(19) United States
(12) Patent Application Publication
(10) Pub. No.: US 2003/0015386 A1
(43) Pub. Date: Jan. 23, 2003

(54) Force distribution components and spreader components with contactable substantially flat face portions for force transmission

(76) Inventor: Stephen A. Gummow, Rockton, IL (US)

Correspondence Address: GROSSMAN, PATTI & BRILL, ONE NORTH LASALLE STREET, 44TH FLOOR, CHICAGO, IL, 60602, US

(21) Appl. No.: 09/911,010

(22) Filed: Jul. 23, 2001

(51) Int. Cl. B25B 13/46

(52) U.S. Cl. 192/43; 81/60

(57) ABSTRACT

Force distribution components of device in one example, upon operative location of the force distribution components relative to one or more force coupler components, are movable among first positions relative to the one or more force coupler components. The force distribution components comprise a force distribution component that comprises one or more substantially flat first face portions. Spreader components of the device are movable among second positions relative to the force distribution components. The spreader components comprise a spreader component that comprises one or more substantially flat second face portions. Location of the spreader components at one or more force transmission position sets of the second positions causes, through employment of contact of one or more of the one or more substantially flat first face portions with one or more of the substantially flat second face portions, location of the force distribution components at one or more force transmission position sets of the first positions.

### TECHNICAL FIELD

The invention in one embodiment relates generally force transmission and more particularly to transmission of force through contacting of face portions of components.

### BACKGROUND

One example of a device that employs force transmission is a tool such as wrench. One example of a wrench comprises a ratchet wrench. One implementation of a ratchet wrench employs a pawl that serves to transfer force to teeth on a gear wheel of the ratchet wrench by engaging only a relatively small part of the wheel at any one time for transmission of force. As one shortcoming, such an implementation employs an undesirable concentration of force between the pawl and the engaged teeth.

Another implementation of a wrench employs roller bearings. In one design of such a wrench, the roller bearings present a shortcoming of having a tendency to undesirably slip upon application of relatively high torque.

Thus, a need exists for enhanced employment of face portions of components for force transmission. A further need exists for enhanced distribution of force that is transmitted through face portions of components.

### SUMMARY

Pursuant to one embodiment of the invention, shortcomings of the existing art are overcome and additional advantages are provided through the provision of force distribution components and spreader components with contactable substantially flat face portions for force transmission.

The invention in one embodiment encompasses a device. The device includes a plurality of force distribution components and a plurality of spreader components. The plurality of force distribution components, upon operative location of the plurality of force distribution components relative to one or more force coupler components, are movable among a plurality of first positions relative to the one or more force coupler components. The plurality of force distribution components comprise a force distribution component that comprises one or more substantially flat first face portions. The plurality of spreader components are movable among a plurality of second positions relative to the plurality of force distribution components. The plurality of spreader components comprise a spreader component that comprises one or more substantially flat second face portions. Location of the plurality of spreader components at one or more force transmission position sets of the plurality of second positions causes, through employment of contact of one or more of the one or more substantially flat first face portions with one or more of the one or more substantially flat second face portions, location of the plurality of force distribution components at one or more force transmission position sets of the plurality of first positions.

Another embodiment of the invention encompasses a device. The device includes a plurality of force distribution components, a plurality of spreader components, and one or more second force coupler components. The plurality of force distribution components, upon operative location of the plurality of force distribution components relative to one or more first force coupler components, are movable among a plurality of first positions relative to the one or more first force coupler components. The plurality of force distribution components comprise a force distribution component that comprises one or more substantially flat first face portions. The plurality of spreader components are movable among a plurality of second positions relative to the plurality of force distribution components. The plurality of spreader components comprise a spreader component that comprises one or more substantially flat second face portions and one or more substantially curved face portions. The one or more second force coupler components are movable among a plurality of third positions relative to the plurality of spreader components. The plurality of force distribution components, the plurality of spreader components, and the one or more second force coupler components serve to allow one or more finite angular movements between the one or more first force coupler components and the plurality of force distribution components. One or more of the one or more finite angular movements is less than or equal to five degrees.

A further embodiment of the invention encompasses a method. There are selected a plurality of force distribution components that, upon operative location of the plurality of force distribution components relative to one or more force coupler components, are movable among a plurality of first positions relative to the one or more force coupler components. The plurality of force distribution components comprise a force distribution component that comprises one or more substantially flat first face portions. There are selected a plurality of spreader components that are movable among a plurality of second positions relative to the plurality of force distribution components. The plurality of spreader components comprise a spreader component that comprises one or more substantially flat second face portions. Location of the plurality of spreader components at one or more force transmission position sets of the plurality of second positions causes, through employment of contact of one or more of the one or more substantially flat first face portions with one or more of the one or more substantially flat second face portions, location of the plurality of force distribution components at one or more force transmission position sets of the plurality of first positions.

These and other features and advantages of one embodiment of the invention will become apparent from the description, the accompanying drawings, and the claims.

### BRIEF DESCRIPTION OF THE DRAWINGS

FIG. 1 is a perspective representation of one example of a device that comprises one or more lever components and one or more unit components.

FIG. 2 is a partial perspective representation of another example of the device of FIG. 1.

FIG. 3 is a side sectional representation of one example of a portion of the device of FIG. 1.

FIG. 4 is an end sectional representation of one example of a portion of the device of FIG. 1.

FIG. 5 is a sectional representation of one example of a portion of the device of FIG. 1, illustrating one exemplary position of one example of a plurality of force distribution components, a plurality of spreader components, a first force coupler component, and a plurality of second force coupler components.

FIG. 6 is similar to FIG. 5, and illustrates a second exemplary position.

FIG. 7 is similar to FIG. 5, and illustrates a third exemplary position.

FIG. 8 is a sectional representation of another example of a portion of the device of FIG. 1.

FIG. 9 is a sectional representation of a further example of a portion of the device of FIG. 1.

FIG. 10 is a partial sectional representation of yet another example of a portion of the device of FIG. 1.

FIG. 11 is a partial sectional representation of a still further example of a portion of the device of FIG. 1.

FIG. 12 is a partial sectional representation of an additional example of a portion of the device of FIG. 1.

FIG. 13 is a partial sectional representation of another example of a portion of the device of FIG. 1.

FIG. 14 is a perspective representation of a further example of the device of FIG. 1.

FIG. 15 is a sectional representation of one example of a portion of the device of FIG. 1, illustrating one exemplary position of one example a plunger component and a plurality of detent components.

FIG. 16 is similar to FIG. 15, and illustrates a second exemplary position.

FIG. 17 is similar to FIG. 15, and illustrates a third exemplary position.

### DETAILED DESCRIPTION

In one embodiment of the invention, substantially flat face portions of force distribution components and spreader components are contactable for force transmission. A detailed discussion of one exemplary embodiment of the invention is presented herein, for illustrative purposes.

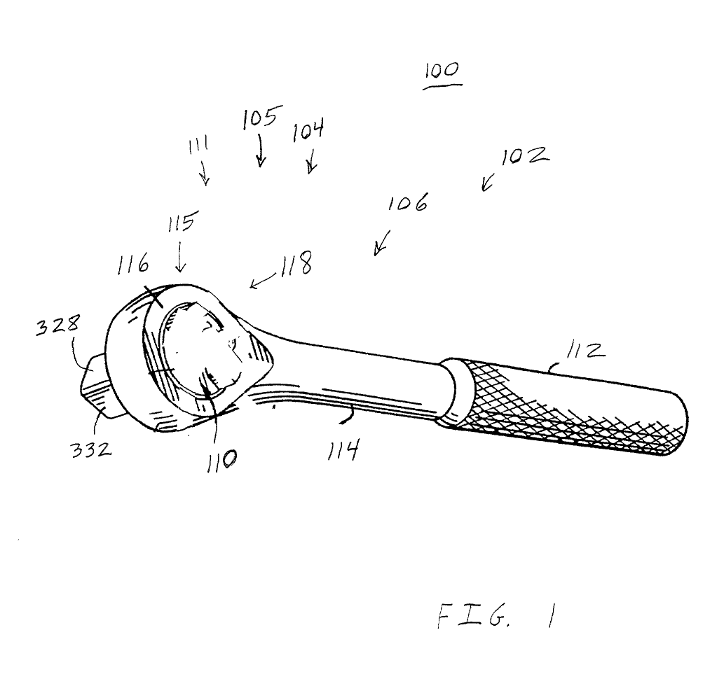

Turning to FIG. 1, device 100, in one example, includes a plurality of components such as hardware components. A number of such components can be combined or divided in one example of device 100, as will be appreciated by those skilled in the art.

Referring again to FIG. 1, device 100 in one example comprises tool 102. An exemplary instance of tool 102 comprises wrench 104. Wrench 104 in one example comprises socket wrench 105. In one example, device 100 comprises one or more instances of lever component 106 and one or more instances of unit component 110.

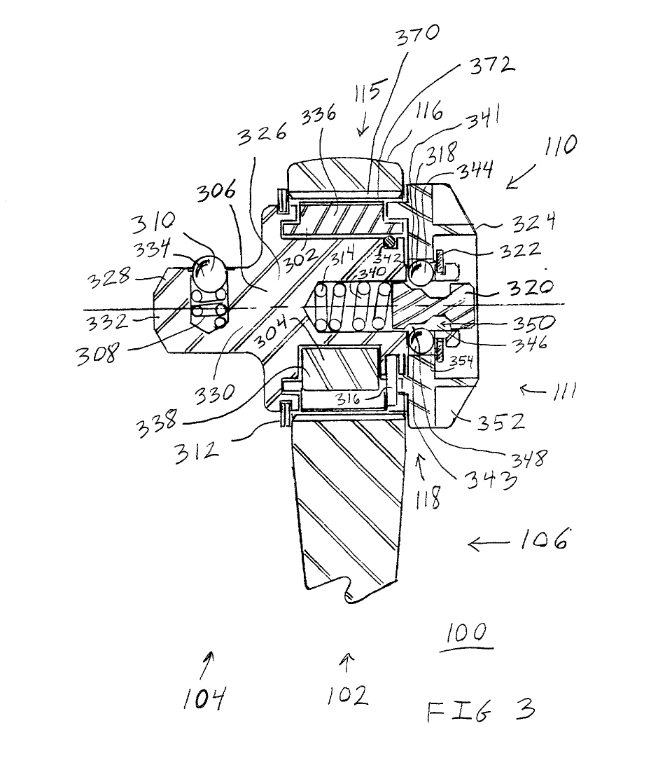

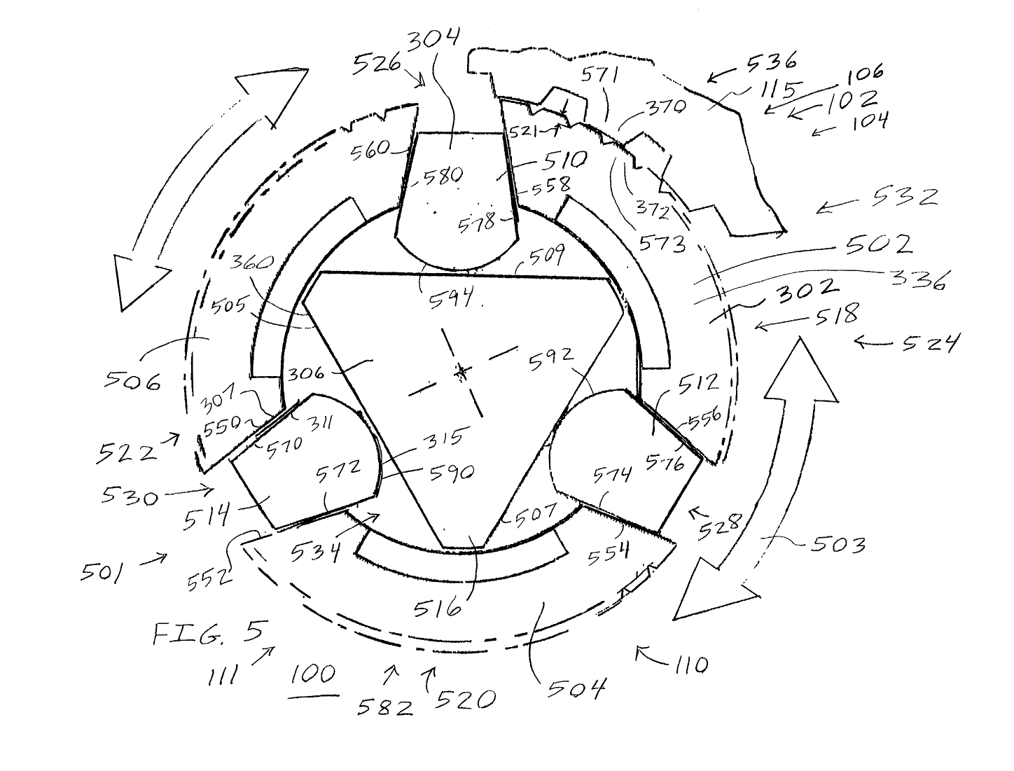

Still referring to FIG. 1, lever component 106 in one example comprises one or more instances of handle component 112, one or more instances of neck component 114, and one or more instances of force coupler component 115. Force coupler component 115 in one example comprises head component 116 and/or one or more instances of protuberance 370 (FIG. 3). Protuberance 370 in one example comprises gear tooth 571 (FIG. 5). One exemplary implementation of handle component 112, neck component 114, and head component 116 is disclosed in U.S. Pat. No. 4,924,737 to Gummow (entitled “Positive Drive Ratchet,” issued May 15, 1990, and assigned to Gummow Tool Company).

In one example, referring to FIG. 1, force coupler component 115 comprises opening 118. Opening 118 in one example serves to receive unit component 110, as described herein. For example, lever component 106 comprises a standard, commercially-available part. A first exemplary ratchet wrench that comprises a lever component and a pawl mechanism drive element (not shown) is offered under the trade identifier “HUSKY 22201 USA” by Husky Professional Tools, 1304 Champion Circle, Carrollton, Tex., 75006, U.S.A. A second exemplary ratchet wrench that comprises a lever component and a pawl mechanism drive element is offered under the trade identifier “SNAP-ON F872” by Snap-on Incorporated, 2801- 80^{th} Street, Kenosha, Wis., 53143, U.S.A. In one example, a user employs the lever component of such a (e.g., standard) ratchet wrench as lever component 106, and advantageously substitutes unit component 110 for the pawl mechanism drive element, as will be appreciated by those skilled in the art. For example, unit component 110 is operatively connectable with and/or disconnectable from one or more instances of lever component 106 as a unit, as described herein.

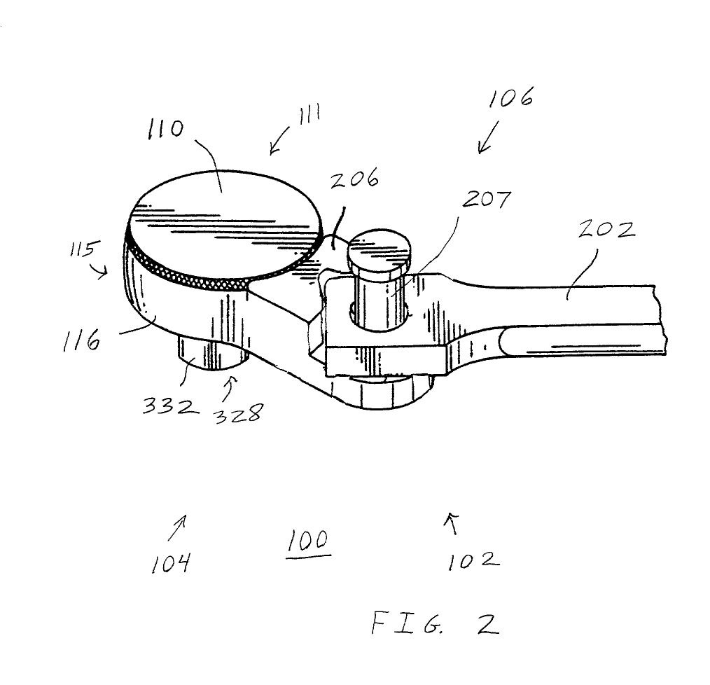

Turning to FIG. 2, in another example, lever component 106 comprises one or more instances of lever component 202 and one or more instances of lever component 206. Lever component 206 in one example is pivotably connectable with lever component 202. In one example, lever component 206 comprises one or more instances of force coupler component 115 and pivot component 207. Pivot component 207 in one example serves to pivotably connect lever components 202 and 206. One exemplary implementation of lever components 202 and 206 is disclosed in U.S. Pat. No. 6,247,386 to Gummow (entitled “Dual Action Indexable Wrench” and issued Jun. 19, 2001). A further exemplary implementation of lever components 202 and 206 is offered under the trade identifiers “HUSKY 24900” and “Indexible Ratchet” by Husky Professional Tools, 1304 Champion Circle, Carrollton, Tex., 75006, U.S.A.

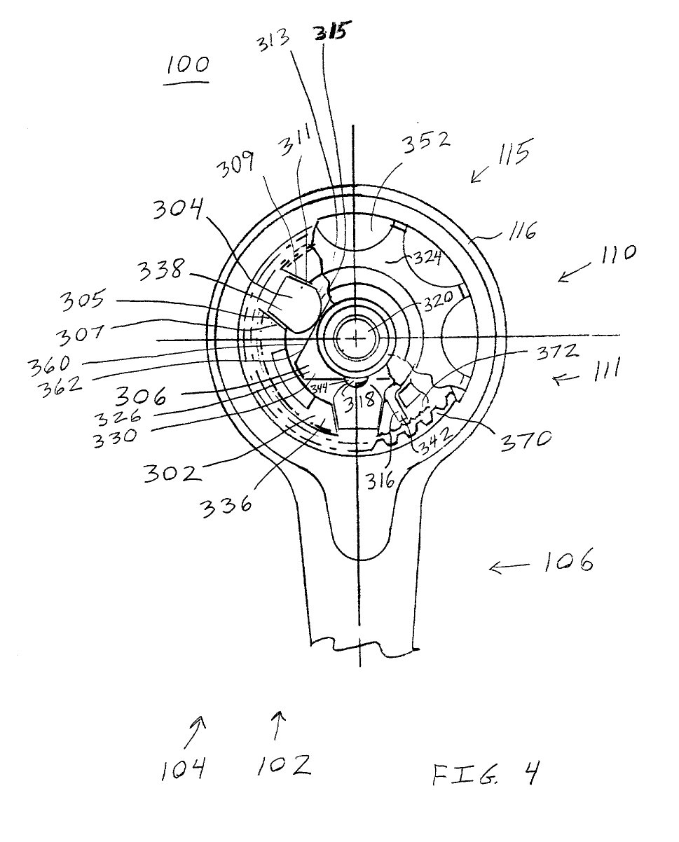

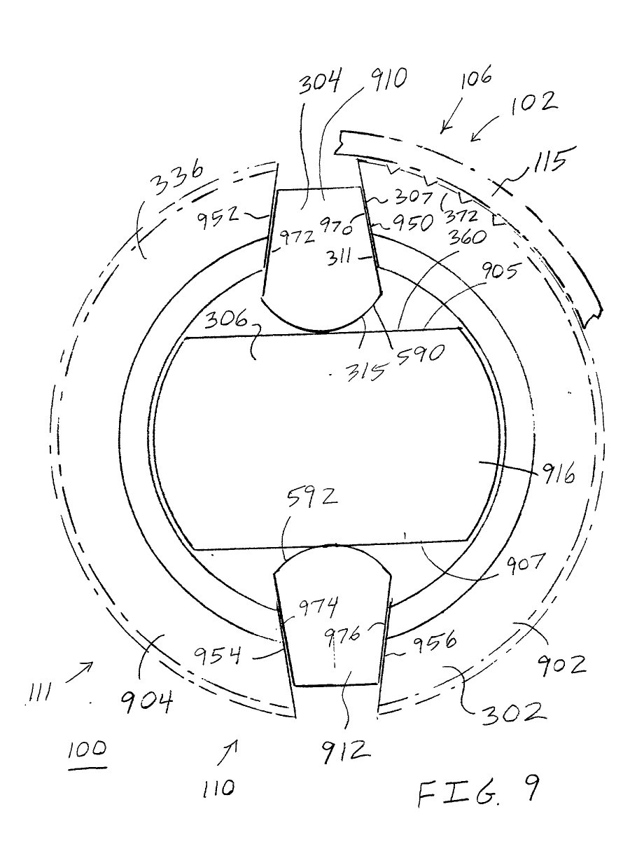

Turning to FIGS. 3-4, unit component 110 in one example comprises one or more instances of force distribution component 302 and one or more instances of spreader component 304. In one example, referring to FIGS. 3-8, unit component 110 comprises three instances of force distribution component 302 and three instances of spreader component 304. In another example, referring to FIG. 9, unit component 110 comprises two instances of force distribution component 302 and two instances of spreader component 304. In a further example, unit component 110 comprises any number of instances of force distribution component 302 and any number of instances of spreader component 304.

Referring further to FIGS. 3-4, unit component 110 in one example comprises one or more of one or more instances of force distribution component 302, one or more instances of spreader component 304, one or more instances of force coupler component 306, one or more instances of spring component 308, one or more instances of detent component 310, one or more instances of snap ring component 312, one or more instances of spring component 314, one or more instances of spring component 316, one or more instances of detent component 318, one or more instances of plunger component 320, one or more instances of snap ring component 322, and one or more instances of cap component 324. In one example, unit component 110 is operatively connectable with and/or disconnectable from one or more instances of force coupler component 115 as a unit.

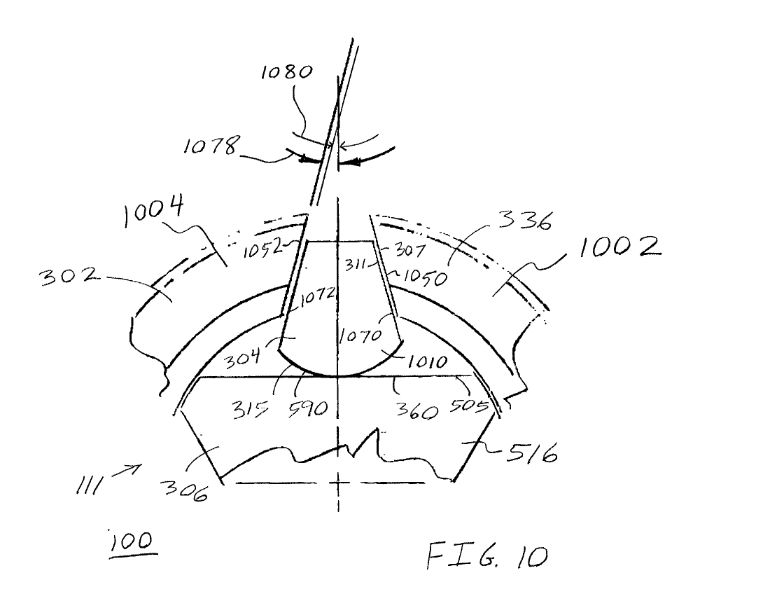

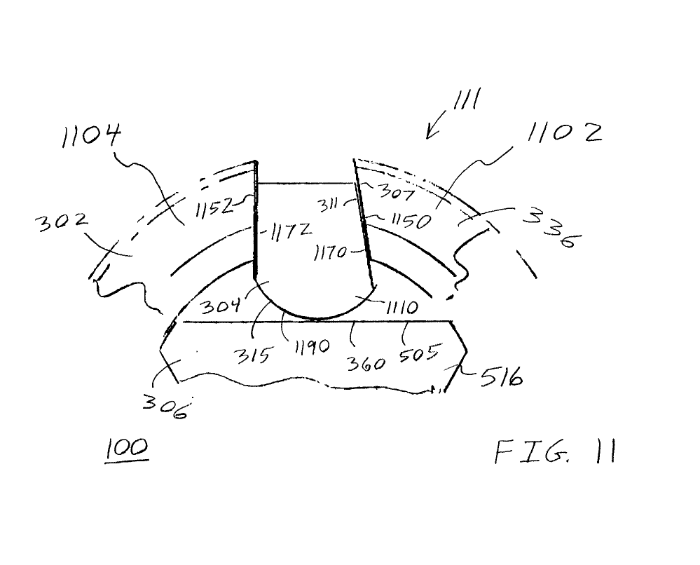

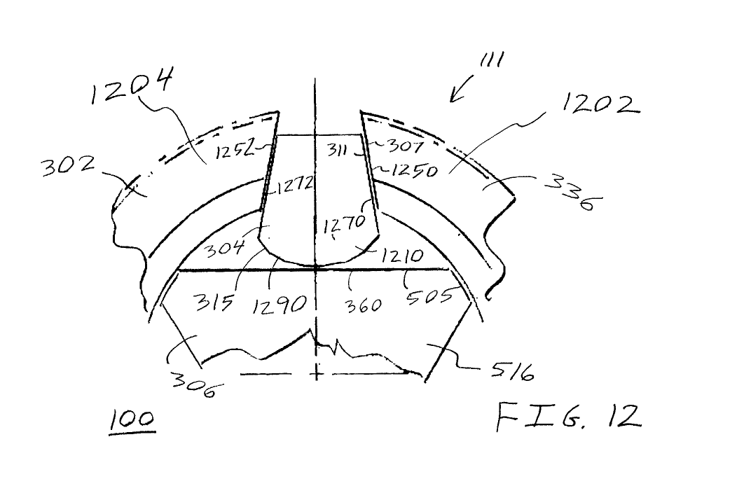

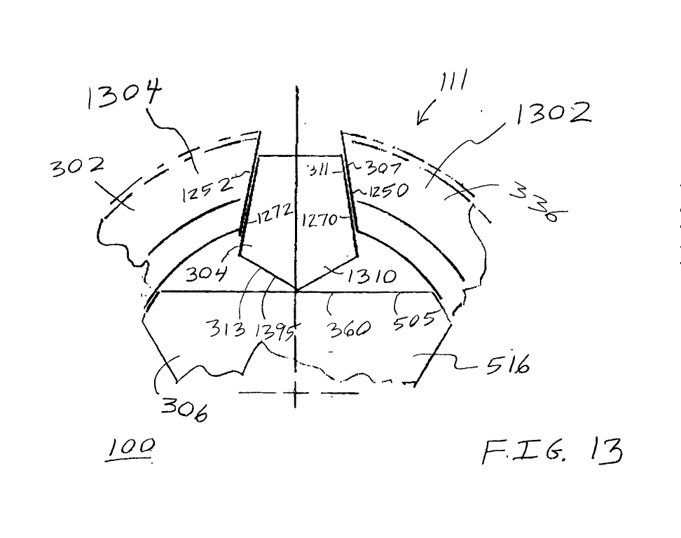

Again referring to FIGS. 3-4, exemplary instances of force distribution component 302 comprise gear shoe component 336 and force distribution components 502 (FIG. 5), 504 (FIG. 5), 506 (FIG. 5), 902 (FIG. 9), 904 (FIG. 9), 1002 (FIG. 10), 1004 (FIG. 10), 1102 (FIG. 11), 1104 (FIG. 11), 1202 (FIG. 12), 1204 (FIG. 12), 1302 (FIG. 13), and 1304 (FIG. 13). Force distribution component 302 in one example comprises one or more instances of face portion 305 and/or one or more instances of protuberance 372. Protuberance 372 in one example comprises dimension 521 (FIG. 5). Dimension 521 in one example comprises a radial depth dimension for protuberance 372 of force distribution component 302. In one example dimension 521 is less than or equal to 0.000102 meters (0.004 inches) and greater than or equal to 0.000305 meters (0.012 inches). For example, dimension 521 is (e.g., approximately) 0.000203 meters (0.008 inches). In a further example, protuberance 372 comprises gear tooth 573 (FIG. 5). Face portion 305 in one example comprises substantially flat face portion 307. Exemplary instances of substantially flat face portion 307 comprise substantially flat face portions 550 (FIG. 5), 552 (FIG. 5), 554 (FIG. 5), 556 (FIG. 5), 558 (FIG. 5), 560 (FIG. 5), 950 (FIG. 9), 952 (FIG. 9), 954 (FIG. 9), 956 (FIG. 9), 1050 (FIG. 10), 1052 (FIG. 10), 1150 (FIG. 11), 1152 (FIG. 11), 1250 (FIG. 12), and 1252 (FIG. 12). Gear shoe component 336 in one example comprises one or more instances of gear tooth 573. In one example, gear shoe component 336 in one example comprises a portion of a continuous or segmented curve, arc, and/or a closed loop. For example, force distribution components 502, 504, and 506 comprise gear shoe 582 (FIG. 5), as will be appreciated by those skilled in the art.

In one example, referring to FIGS. 3-4, substantially flat face portion 307 comprises an entirety of a face of an instance of force distribution component 302. In another example, substantially flat face portion 307 in one example comprises a sub-part of a face of an instance of force distribution component 302. For example, a face of a component comprises one or more sub-parts that comprise an instance of substantially flat face portion 307 and one or more sub-parts that comprise an instance of a non-flat face portion, as will be appreciated by those skilled in the art.

Further referring to FIGS. 3-4, exemplary instances of spreader component 304 comprise wedge component 338 and spreader components 510 (FIG. 5), 512 (FIG. 5), 514 (FIG. 5), 910 (FIG. 9), 912 (FIG. 9), 1010 (FIG. 10), 1110 (FIG. 11), 1210 (FIG. 12), and 1310 (FIG. 13). Wedge component 338 in one example comprises a taper that is directed radially outward from unit component 110. Spreader component 304 in one example comprises one or more instances of face portions 309 and 313. Face portion 309 in one example comprises substantially flat face portion 311. Exemplary instances of substantially flat face portion 311 comprise substantially flat face portions 570 (FIG. 5), 572 (FIG. 5), 574 (FIG. 5), 576 (FIG. 5), 578 (FIG. 5), 580 (FIG. 5), 970 (FIG. 9), 972 (FIG. 9), 974 (FIG. 9), 976 (FIG. 9), 1070 (FIG. 10), 1072 (FIG. 10), 1170 (FIG. 11), 1172 (FIG. 11), 1270 (FIG. 12), and 1272 (FIG. 12).

Now referring to FIGS. 4 and 10, an instance of substantially flat face portion 307 of an instance of force distribution component 302 in one example comprises a shape that is suited to one or more of receive, mate with, and complement a shape of an instance of substantially flat face portion 311 of an instance of spreader component 304 that is intended for (e.g., sliding) contact with the instance of substantially flat face portion 307. For example, corresponding shapes of instances of substantially flat face portions 307 and 311 of an instance of unit component 110 serve, at intended maximal outward radial expansion of gear shoe 382, advantageously to stop instances of spreader component 304 short of extending radially further than instances of distribution component 302, for instance, to advantageously promote avoidance of direct force transmission contact between a portion of spreader component 304 and a portion of force coupler component 115, as will be appreciated by those skilled in the art.

Again referring to FIGS. 4 and 10, substantially flat face portion 307 of force distribution component 302 in one example comprises rake 1078. Rake 1078 in one example is less than or equal to forty degrees and greater than or equal to five degrees. For example, rake 1078 is less than or equal to thirty degrees and greater than or equal to eight degrees. In one example, rake 1078 is (e.g., approximately) fifteen degrees. In another example, rake 1078 is (e.g., approximately) ten degrees. Referring to FIG. 10, an instance of force distribution component 302 in one example comprises substantially flat face portions 1050 and 1052 that comprise (e.g., approximately) equal values for rake 1078. Referring to FIG. 11, an instance of force distribution component 302 in one example comprises substantially flat face portions 1150 and 1152 that comprise different values for rake 1078.

Referring still to FIGS. 4 and 10, substantially flat face portion 311 of spreader component 304 in one example comprises rake 1080. Rake 1080 in one example is less than or equal to forty degrees and greater than or equal to five degrees. For example, rake 1080 is less than or equal to thirty degrees and greater than or equal to eight degrees. In one example, rake 1080 is (e.g., approximately) fifteen degrees. In another example, rake 1080 is (e.g., approximately) ten degrees. Referring to FIG. 10, an instance of spreader component 304 in one example comprises substantially flat face portions 1070 and 1072 that comprise (e.g., approximately) equal values for rake 1080. Referring to FIG. 11, an instance of spreader component 304 in one example comprises substantially flat face portions 1170 and 1172 that comprise different values for rake 1080.

In one example, referring to FIGS. 3-4, substantially flat face portion 311 comprises an entirety of a face of an instance of spreader component 304. In another example, substantially flat face portion 311 in one example comprises a sub-part of a face of an instance of spreader component 304. For example, a face of a component comprises one or more sub-parts that comprise an instance of substantially flat face portion 311 and one or more sub-parts that comprise an instance of a non-flat face portion, as will be appreciated by those skilled in the art.

Referring still to FIGS. 3-4, face portion 313 in one example comprises substantially curved face portion 315. Exemplary instances of substantially curved face portion 315 comprise substantially curved face portions 590 (FIG. 5), 592 (FIG. 5), 594 (FIG. 5), 1190 (FIG. 11), and 1290 (FIG. 12). An additional exemplary instance of face portion 313 comprises face portion 1395 (FIG. 13).

An illustrative description of exemplary operation of one or more instances of force distribution component 302 and one or more instances of spreader component 304 is presented herein, for explanatory purposes.

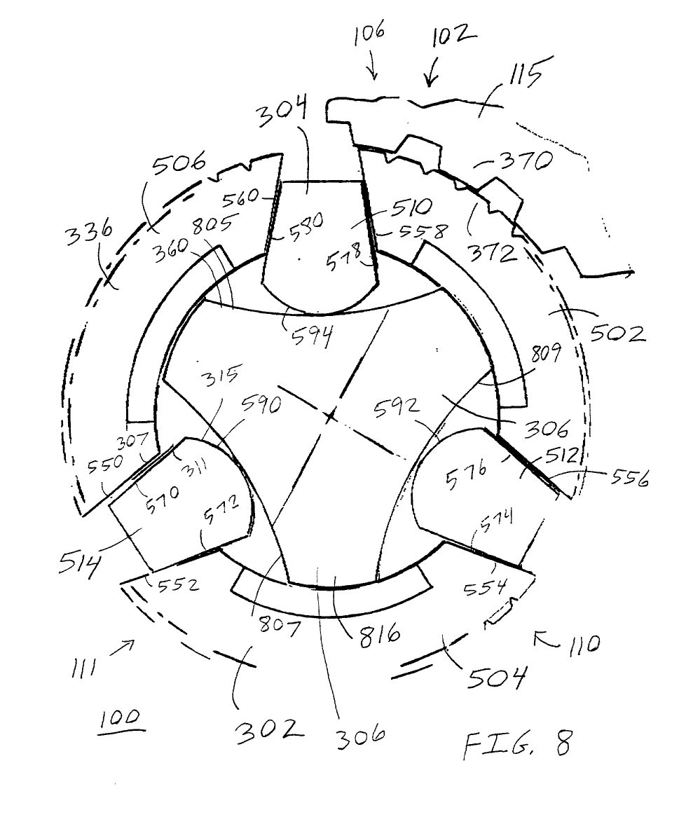

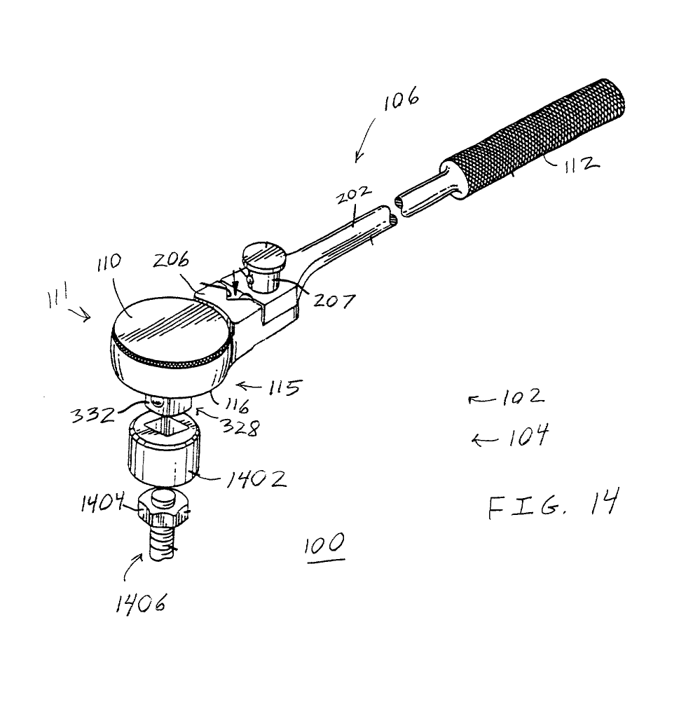

Still referring to FIGS. 3-4, exemplary instances of force coupler component 306 comprise force coupler components 516 (FIG. 5), 816 (FIG. 8), and 916 (FIG. 9). Force coupler component 306 in one example comprises one or more instances of face portion 360. Face portion 360 in one example comprises substantially flat face portion 362. Exemplary instances of face portion 360 comprise substantially flat face portions 505 (FIG. 5), 507 (FIG. 5), and 509 (FIG. 5), substantially curved face portions 805 (FIG. 8), 807 (FIG. 8), and 809 (FIG. 8), and substantially flat face portions 905 (FIG. 9) and 907 (FIG. 9). In a further example, force coupler component 306 comprises central pivot component 326 and drive component 328. Central pivot component 326 in one example comprises center body component 330. Drive component 328 in one example comprises drive tang component 332. In one example, drive component 328 serves to removably engage socket 1402 (FIG. 14). For example, drive component 328 telescopes in the socket. In a further example, drive component 328 transmits force to the socket. For example, drive component 328 serves to transmit rotational force to the socket, for example, for subsequent force transmission to head 1404 (FIG. 14) of bolt 1406 (FIG. 14), as will be appreciated by those skilled in the art.

Further referring to FIGS. 3-4, unit component 110 in one example serves to allow one or more advantageously small instances of finite angular movement 111 between one or more instances of force coupler component 115 and a plurality of instances of force distribution component 304. For example, a plurality of instances of force distribution component 302, a plurality of instances of spreader component 304, and one or more instances of force coupler component 306 in one example serve to allow the one or more instances of finite angular movement 111. In one example, one or more of the one or more instances of finite angular movement 111 is less than or equal to five degrees. In another example, one or more of the one or more instances of finite angular movement 111 is less than or equal to four degrees. In a further example, one or more of the one or more instances of finite angular movement 111 is less than or equal to three degrees. In a still further example, unit component 110 serves to allow a plurality of instances of finite angular movement 111 to be substantially uniform in size, for example, varying by less than one half of a degree.

Referring again to FIGS. 3-4, detent component 310 in one example comprises ball detent component 334. In one example, detent component 310 and spring component 308 serve to present a defined threshold of force for removable engagement of drive component 328 with socket 1402 (FIG. 14). In one example, socket 1402 comprises a recess (not shown) for receiving a portion of detent component 310. In one example, the threshold of removable force insertion presented by detent component 310 upon sliding insertion and removal from the recess of socket 1402 serves to advantageously increase one or more of security, safety, sturdiness, and effective force transmitability in operation of device 100, as will be appreciated by those skilled in the art.

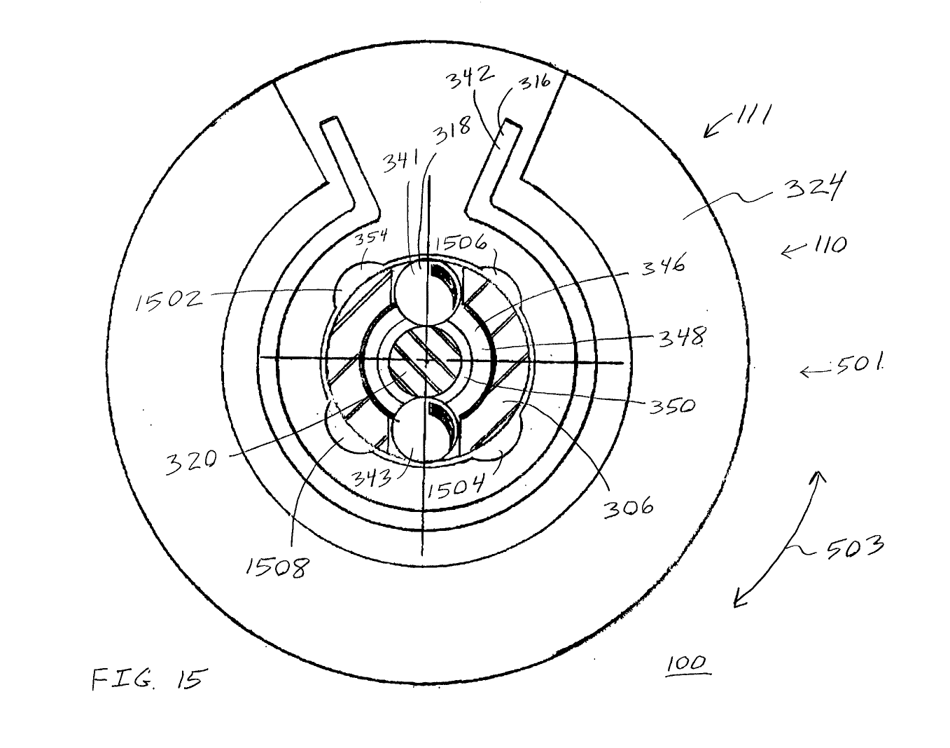

Further referring to FIGS. 3-4, spring component 314 in one example comprises plunger spring component 340. Spring component 316 in one example comprises reversal spring component 342. Detent component 318 in one example comprises ball detent component 344. Exemplary instances of detent component 318 comprise detent components 341 and 343. Plunger component 320 in one example comprises one or more instances of passage 346. Passage 346 in one example comprises a track. Exemplary instances of passage 346 comprise passages 348 and 350. Cap component 324 in one example comprises one or more instances of grip component 352 and one or more instances of recess 354. Grip component 352 in one example comprises one or more of an indentation, a groove, a notch, and a thread. In one example, grip component 352 serves to improve an ability of a user to manipulate cap component 324. Exemplary instances of recess 354 comprise recesses 1502 (FIG. 15), 1504 (FIG. 15), 1506 (FIG. 15), and 1508 (FIG. 15). An illustrative description of exemplary operation of one or more instances of detent component 318, one or more instances of plunger component 320, and one or more instances of cap component 324 is presented herein, for explanatory purposes.

Now is presented an illustrative description of exemplary operation of one or more instances of force distribution component 302, one or more instances of spreader component 304, one or more instances of central pivot component 306, one or more instances of force coupler component 115, one or more instances of detent component 318, one or more instances of plunger component 320, and one or more instances of cap component 324.

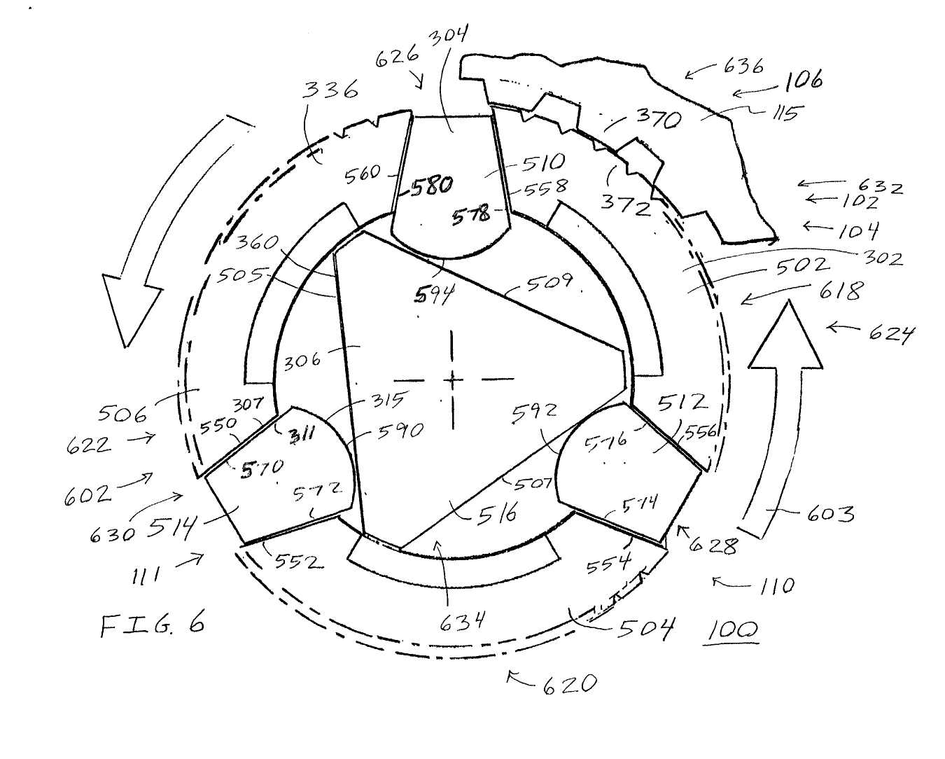

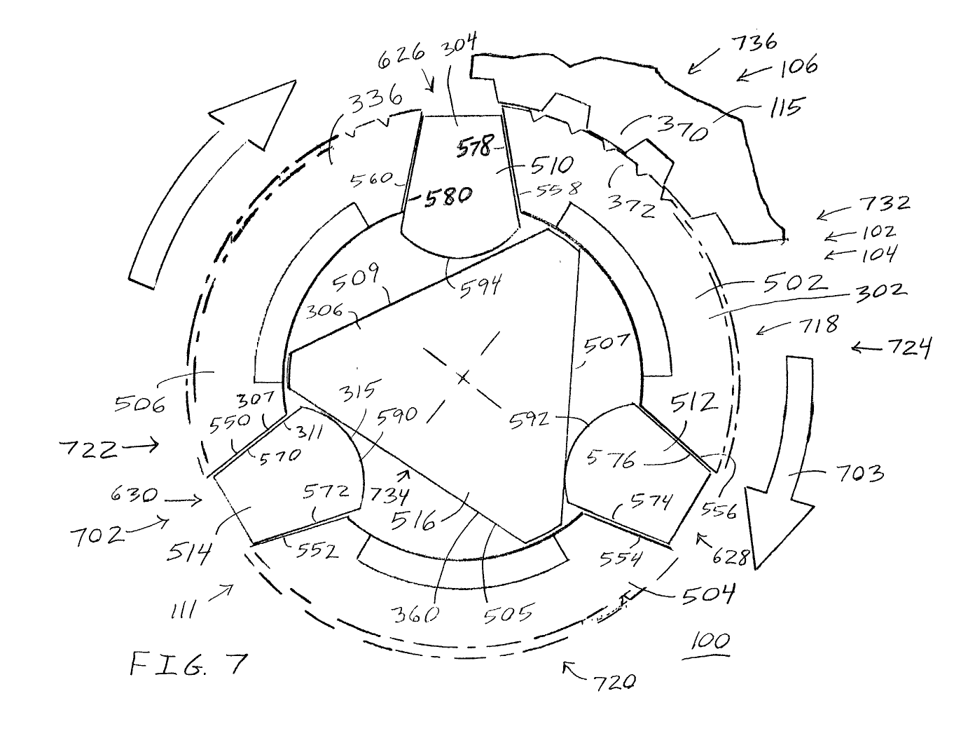

Turning to FIGS. 5 and 15, unit component 110 of device 100 in one example is located at position 501. Position 501 in one example serves as a transitional position between positions 602 (FIG. 6) and 702 (FIG. 7), as described herein. In one example, position 501 comprises a position of neutral (e.g., angular) movement of unit component 110 of device 100. For example, directions 503 are available to unit component 110 at position 501 for angular movement with substantially no force transmission to one or more instances of force coupler component 115, as will be appreciated by those skilled in the art.

Referring now to FIGS. 3 and 15, in one example a user locates unit component 110 at position 501 by pressing plunger component 320 in a direction inward to device that presses plunger component 320 against spring component 314 to compress spring component 314 until exposing and/or introducing passage 350 to detent components 341 and 343, as will be appreciated by those skilled in the art.

Referring to FIG. 5, at position 501 of unit component 110 in one example, force distribution components 502, 504, and 506 are located at positions 518, 520, and 522, respectively. Positions 518, 520, and 522 in one example comprise set 524 of positions for a plurality of instances of force distribution component 302. Spreader components 510, 512, and 514 in one example are located at positions 526, 528, and 530. Positions 526, 528, and 530 in one example comprise set 532 of positions for a plurality of instances of spreader component 304. Sets 524 and 532 of positions in one example comprises positions of relatively unforced fit and/or contact between substantially flat face portions 550, 552, 554, 556, 558, 560 and substantially flat face portions 570, 572, 574, 576, 578, 580, respectively. For example, sets 524 and 532 of positions comprise neutral positions of force distribution component 302 and spreader component 304.

Again referring to FIG. 5, at position 501 of unit component 110, force coupler components 516 and 115 in one example are located at positions 534 and 536, respectively. In one example, position 534 of force coupler component 516 comprises a position of forced contact and/or engagement between force coupler component 516 and socket 1402 (FIG. 14) and/or between force coupler component 516 and spreader components 510, 512, and 514. In another example, position 534 of force coupler component 516 comprises a position of relatively unforced contact and/or engagement between force coupler component 516 and socket 1402 (FIG. 14) and/or between force coupler component 516 and spreader components 510, 512, and 514. Position 536 of force coupler component 115 in one example comprises a position of relative, rotational, substantially non-force transmission between force coupler component 115 and force distribution components 502, 504, and 506. For example, position 536 comprises a neutral position of force coupler component 115.

Referring to FIG. 15, at position 501 of unit component 110 in one example plunger component 320, upon receipt of one or more instances of detent component 318 in one or more instances of passage 346, serves to allow relocation of one or more instances of detent component 318 among one or more instances of recess 354. For example, plunger component 320, upon receipt of detent components 341 and 343 in passage 350, serves to allow relocation of detent components 341 and 343 from recesses 1502 and 1504 to recesses 1506 and 1508, or from recesses 1506 and 1508 to recesses 1502 and 1504. For example, a user moves, pivots, and/or rotates cap component 324 to obtain relocation of detent components 341 and 343 among instances of recess 354, as will be appreciated by those skilled in the art.

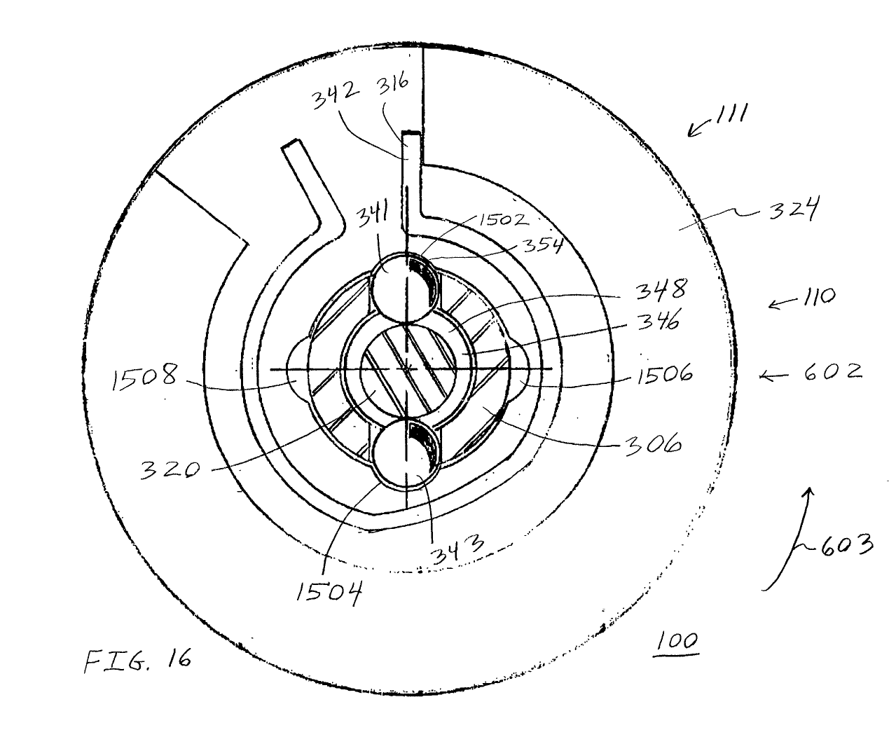

Turning to FIGS. 6 and 16, unit component 110 of device 100 in one example is located at position 602. In one example, position 602 comprises a position of forward and/or counterclockwise angular movement of unit component 110 of device 100. For example, direction 603 is available to unit component 110 at position 602 for angular movement that causes force transmission with one or more instances of force coupler component 115. At position 602 in one example, an angular direction opposite to direction 603 is available to lever component 106 for angular rotation of lever component 106. Device 100 in one example serves to allow one or more instances of finite angular movement 111 of lever component 106 with unit component in direction 603, and/or one or more instances of finite angular movement 111 of lever component 106 without unit component 100 in an angular direction opposite to direction 603, as will be appreciated by those skilled in the art.

Still referring to FIGS. 6 and 16, at position 602 in one example one or more instances of finite angular movement 111 of lever component 106 with unit component in direction 603 serves to abut and/or engage a portion of one or more instances of protuberance 372 with a portion of one or more instances of protuberance 370, for example, to promote force transmission between a plurality of instances of force distribution component 302 and one or more instances of force coupler component 115. In a further example, at position 602 one or more instances of finite angular movement 111 of lever component 106 without unit component 100 in an angular direction opposite to direction 603 serves to contact a portion of one or more instances of protuberance 372 with a portion of one or more instances of protuberance 370, for example, to produce one or more audible sounds, for instance, one or more clicks. One or more of abutment, engagement, and contact of a portion of one or more instances of protuberance 372 with a portion of one or more instances of protuberance 370 at position 602 in one example serves to present to a user of device 100 a sound and/or feel of a ratchet wrench that comprises a lever component and a pawl mechanism drive element (not shown).

Referring to FIG. 6, at position 602 of unit component 110 in one example, force distribution components 502, 504, and 506 are located at positions 618, 620, and 622, respectively. Positions 618, 620, and 622 in one example comprise set 624 of positions for a plurality of instances of force distribution component 302. Spreader components 510, 512, and 514 in one example are located at positions 626, 628, and 630. Positions 626, 628, and 630 in one example comprise set 632 of positions for a plurality of instances of spreader component 304. Sets 624 and 632 of positions in one example comprises positions of relatively forced fit and/or contact between substantially flat face portions 550, 552, 554, 556, 558, 560 and substantially flat face portions 570, 572, 574, 576, 578, 580, respectively. For example, sets 624 and 632 of positions comprise forward and/or counterclockwise torque positions of force distribution component 302 and spreader component 304.

Again referring to FIG. 6, at position 602 of unit component 110, force coupler components 516 and 115 in one example are located at positions 634 and 636, respectively. Position 634 of force coupler component 516 in one example comprises a position of forced contact and/or engagement between force coupler component 516 and socket 1402 (FIG. 14) as well as between force coupler component 516 and spreader components 510, 512, and 514. Position 636 of force coupler component 115 in one example comprises a position of forced contact and/or engagement between force coupler component 115 and force distribution components 502, 504, and 506.

Referring to FIG. 16, at position 602 of unit component 110 in one example cap component 324, upon receipt of one or more instances of detent component 318 in one or more instances of recess 354 and in one or more instances of passage 346, serves to allow force transmission between one or more instances of force coupler component 115 and unit component 110 based on direction 603 of angular rotation of unit component 110. For example, cap component 324, upon receipt of detent components 341 and 343 in recesses 1502 and 1504, respectively, and in passage 348, serves to allow force transmission between one or more instances of force coupler component 115 and unit component 110 based on direction 603 of angular rotation of unit component 110.

At position 602 in one example, referring to FIGS. 6 and 16, angular rotation of force coupler component 516 in direction 603 serves to contact force coupler component 516 with spreader components 510, 512, and 514 and press spreader components 510, 512, and 514 into force distribution components 502, 504, and 506 to press force distribution components 502, 504, and 506 against force coupler component 115 for force transmission to force coupler component 115 in direction 603. Pressing of spreader components 510, 512, and 514 into force distribution components 502, 504, and 506 in one example comprises sliding contact of substantially flat face portions 550, 552, 554, 556, 558, 560 with substantially flat face portions 570, 572, 574, 576, 578, 580, respectively, that in one example results in radially outward movement and compressive contact among spreader components 510, 512, and 514 and force distribution components 502, 504, and 506.

Further referring to FIGS. 6 and 16, at position 602 in another example angular rotation of force coupler component 115 in direction 603 presses force coupler component 115 against force distribution components 502, 504, and 506 to press together force distribution components 502, 504, and 506 and spreader components 510, 512, and 514 while pressing spreader components 510, 512, and 514 against force coupler component 516 for force transmission to force coupler component 516 in direction 603. Pressing together of spreader components 510, 512, and 514 and force distribution components 502, 504, and 506 in one example comprises sliding contact of substantially flat face portions 550, 552, 554, 556, 558, 560 with substantially flat face portions 570, 572, 574, 576, 578, 580, respectively, that in one example results in radially outward movement and compressive contact among spreader components 510, 512, and 514 and force distribution components 502, 504, and 506.

Referring to FIGS. 6 and 10, sliding contact of substantially flat face portions 550, 552, 554, 556, 558, 560 in one example comprises employment of respective instances of rake 1078. In a further example, sliding contact of substantially flat face portions 570, 572, 574, 576, 578, 580 comprises employment of respective instances of rake 1080. In one example, a plurality of instances of rake 1078 and/or 1080 serve to advantageously one or more or distribute, enhance, and increase security of force transmitted from force coupler component 516, through spreader components 510, 512, and 514, through force distribution components 502, 504, and 506, to force coupler component 115. In a further example, a plurality of instances of rake 1078 and/or 1080 serve to advantageously one or more or distribute, enhance, and increase security of force transmitted from force coupler component 115, through force distribution components 502, 504, through spreader components 510, 512, and 514, and 506, to force coupler component 516.

Referring again to FIGS. 6 and 16, contact of force coupler component 516 with spreader components 510, 512, and 514 in one example comprises camming contact of substantially flat face portions 505, 507, and 509 with substantially curved face portions 590, 592, 594, respectively. Camming contact in one example comprises contact among a substantially curved face portion with one or more other face portions, one or more of which in one example are substantially curved, in another example are substantially flat, and in yet another example comprise one or more other shapes, as will be appreciated by those skilled in the art.

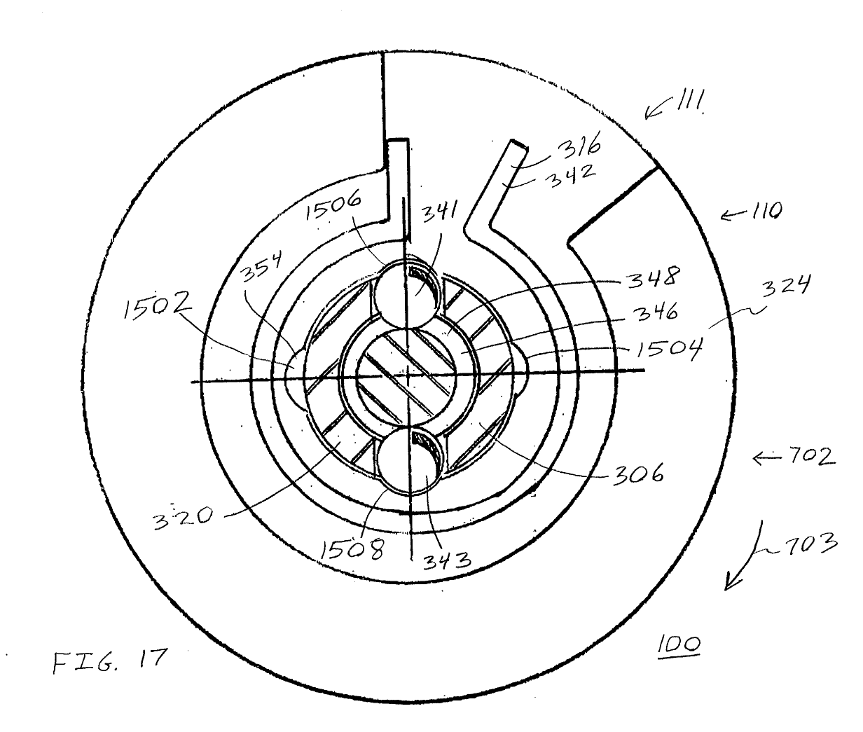

Turning to FIGS. 7 and 17, unit component 110 of device 100 in one example is located at position 702. In one example, position 702 comprises a position of reverse and/or clockwise angular movement of unit component 110 of device 100. For example, direction 703 is available to unit component 110 at position 702 for angular movement that causes force transmission with one or more instances of force coupler component 115. At position 702 in one example, an angular direction opposite to direction 703 is available to lever component 106 for angular rotation of lever component 106. Device 100 in one example serves to allow one or more instances of finite angular movement 111 of lever component 106 with unit component in direction 703, and/or one or more instances of finite angular movement 111 of lever component 106 without unit component 100 in an angular direction opposite to direction 703, as will be appreciated by those skilled in the art.

Still referring to FIGS. 7 and 17, at position 702 in one example one or more instances of finite angular movement 111 of lever component 106 with unit component in direction 703 serves to abut and/or engage a portion of one or more instances of protuberance 372 with a portion of one or more instances of protuberance 370, for example, to promote force transmission between a plurality of instances of force distribution component 302 and one or more instances of force coupler component 115. In a further example, at position 702 one or more instances of finite angular movement 111 of lever component 106 without unit component 100 in an angular direction opposite to direction 703 serves to contact a portion of one or more instances of protuberance 372 with a portion of one or more instances of protuberance 370, for example, to produce one or more audible sounds, for instance, one or more clicks. One or more of abutment, engagement, and contact of a portion of one or more instances of protuberance 372 with a portion of one or more instances of protuberance 370 at position 702 in one example serves to present to a user of device 100 a sound and/or feel of a ratchet wrench that comprises a lever component and a pawl mechanism drive element (not shown).

Referring to FIG. 7, at position 702 of unit component 110, force distribution components 502, 504, and 506 in one example are located at positions 718, 720, and 722, respectively. Positions 718, 720, and 722 in one example comprise set 724 of positions for a plurality of instances of force distribution component 302. Spreader components 510, 512, and 514 in one example are located at positions 726, 728, and 730. Positions 726, 728, and 730 in one example comprise set 732 of positions for a plurality of instances of spreader component 304. Sets 724 and 732 of positions in one example comprises positions of relatively forced fit and/or contact between substantially flat face portions 550, 552, 554, 556, 558, 560 and substantially flat face portions 570, 572, 574, 576, 578, 580, respectively. For example, sets 724 and 732 of positions comprise reverse and/or clockwise torque positions of force distribution component 302 and spreader component 304.

Again referring to FIG. 7, at position 702 of unit component 110, force coupler components 516 and 115 in one example are located at positions 734 and 736, respectively. Position 734 of force coupler component 516 in one example comprises a position of forced contact and/or engagement between force coupler component 516 and socket 1402 (FIG. 14) as well as between force coupler component 516 and spreader components 510, 512, and 514. Position 736 of force coupler component 115 in one example comprises a position of forced contact and/or engagement between force coupler component 115 and force distribution components 502, 504, and 506.

Referring to FIG. 17, at position 702 of unit component 110, cap component 324, upon receipt of one or more instances of detent component 318 in one or more instances of recess 354 and in one or more instances of passage 346, serves to allow force transmission between one or more instances of force coupler component 115 and unit component 110 based on direction 703 of angular rotation of unit component 110. For example, cap component 324, upon receipt of detent components 341 and 343 in recesses 1506 and 1508, respectively, and in passage 348, serves to allow force transmission between one or more instances of force coupler component 115 and unit component 110 based on direction 703 of angular rotation of unit component 110.

At position 702 in one example, referring to FIGS. 7 and 17, angular rotation of force coupler component 516 in direction 703 presses spreader components 510, 512, and 514 into force distribution components 502, 504, and 506 to press force distribution components 502, 504, and 506 against force coupler component 115 for force transmission to force coupler component 115 in direction 703. Pressing of spreader components 510, 512, and 514 into force distribution components 502, 504, and 506 in one example comprises sliding contact of substantially flat face portions 550, 552, 554, 556, 558, 560 with substantially flat face portions 570, 572, 574, 576, 578, 580, respectively, that in one example results in radially outward movement and compressive contact among spreader components 510, 512, and 514 and force distribution components 502, 504, and 506, as will be appreciated by those skilled in the art.

Further referring to FIGS. 7 and 17, at position 702 in another example angular rotation of force coupler component 115 in direction 703 presses force coupler component 115 against force distribution components 502, 504, and 506 to press together force distribution components 502, 504, and 506 and spreader components 510, 512, and 514 while pressing spreader components 510, 512, and 514 against force coupler component 516 for force transmission to force coupler component 516 in direction 703. Pressing together of spreader components 510, 512, and 514 and force distribution components 502, 504, and 506 in one example comprises sliding contact of substantially flat face portions 550, 552, 554, 556, 558, 560 with substantially flat face portions 570, 572, 574, 576, 578, 580, respectively, that in one example results in radially outward movement and compressive contact among spreader components 510, 512, and 514 and force distribution components 502, 504, and 506, as will be appreciated by those skilled in the art.

Although exemplary embodiments of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

What is claimed is:

1. A device, comprising:
a plurality of force distribution components that, upon operative location of the plurality of force distribution components relative to one or more force coupler components, are movable among a plurality of first positions relative to the one or more force coupler components, wherein the plurality of force distribution components comprise a force distribution component that comprises one or more substantially flat first face portions; and
a plurality of spreader components that are movable among a plurality of second positions relative to the plurality of force distribution components, wherein the plurality of spreader components comprise a spreader component that comprises one or more substantially flat second face portions;
wherein location of the plurality of spreader components at one or more force transmission position sets of the plurality of second positions causes, through employment of contact of one or more of the one or more substantially flat first face portions with one or more of the one or more substantially flat second face portions, location of the plurality of force distribution components at one or more force transmission position sets of the plurality of first positions.

2. The device of claim 1, wherein the force distribution component comprises a first force distribution component, wherein the plurality of force distribution components comprise a second force distribution component that comprises one or more substantially flat third face portions;
wherein the spreader component comprises one or more substantially flat fourth face portions;
wherein the one or more force transmission position sets of the plurality of first positions comprise one or more first force transmission position sets of the plurality of first positions, wherein the one or more force transmission position sets of the plurality of second positions comprise one or more first force transmission position sets of the plurality of second positions;
wherein location of the plurality of spreader components at one or more second force transmission position sets of the plurality of second positions causes, through employment of contact of one or more of the one or more substantially flat third face portions with one or more of the one or more substantially flat fourth face portions, location of the plurality of force distribution components at one or more second force transmission position sets of the plurality of first positions.

3. The device of claim 1, wherein the force distribution component comprises one or more substantially flat third face portions;
wherein the spreader component comprises a first spreader component, wherein the plurality of spreader components comprise a second spreader component that comprises one or more substantially flat fourth face portions;
wherein the one or more force transmission position sets of the plurality of first positions comprise one or more first force transmission position sets of the plurality of first positions, wherein the one or more force transmission position sets of the plurality of second positions comprise one or more first force transmission position sets of the plurality of second positions;
wherein location of the plurality of spreader components at one or more second force transmission position sets of the plurality of second positions causes, through employment of contact of one or more of the one or more substantially flat third face portions with one or more of the one or more substantially flat fourth face portions, location of the plurality of force distribution components at one or more second force transmission position sets of the plurality of first positions.

4. The device of claim 1, wherein the force distribution component comprises a first force distribution component, wherein the plurality of force distribution components comprise a second force distribution component that comprises one or more substantially flat third face portions;
wherein the spreader component comprises a first spreader component, wherein the plurality of spreader components comprise a second spreader component that comprises one or more substantially flat fourth face portions;
wherein the one or more force transmission position sets of the plurality of first positions comprise one or more first force transmission position sets of the plurality of first positions, wherein the one or more force transmission position sets of the plurality of second positions comprise one or more first force transmission position sets of the plurality of second positions;
wherein location of the plurality of spreader components at one or more second force transmission position sets of the plurality of second positions causes, through employment of contact of one or more of the one or more substantially flat third face portions with one or more of the one or more substantially flat fourth face portions, location of the plurality of force distribution components at one or more second force transmission position sets of the plurality of first positions.

5. The device of claim 1, wherein the one or more force coupler components comprise one or more first force coupler components, and further comprising one or more second force coupler components that are movable among a plurality of third positions relative to the plurality of spreader components; and
wherein location of the one or more second force coupler components at one or more force transmission position sets of the plurality of third positions causes, through employment of contact among one or more portions of the spreader component and one or more portions of a force coupler component of the one or more second force coupler components, location of the plurality of spreader components at one or more force transmission position sets of the plurality of second positions.

6. The device of claim 5, wherein one or more of the one or more portions of the spreader component comprise one or more substantially curved face portions of the spreader component;
wherein location of the one or more second force coupler components at one or more force transmission position sets of the plurality of third positions causes, through employment of camming contact among one or more of the one or more substantially curved face portions and one or more portions of a force coupler component of the one or more second force coupler components, location of the plurality of spreader components at one or more force transmission position sets of the plurality of second positions.

7. The device of claim 6, wherein the plurality of spreader components comprise a plurality of wedge components, wherein the spreader component comprises a wedge component of the plurality of wedge components; and
wherein the one or more second force coupler components comprise a wrench central pivot component that is operatively movable among the plurality of third positions relative to the plurality of wedge components.

8. The device of claim 5, wherein a pivot of one or more of the one or more second force coupler components from a first instance of the plurality of third positions to a second instance of the plurality of third positions, upon operative location of the plurality of force distribution components relative to the one or more force coupler components, serves to press the plurality of spreader components against the plurality of force distribution components and cause the plurality of force distribution components to press against the one or more first force coupler components.

9. The device of claim 5, wherein the plurality of force distribution components, the plurality of spreader components, and the one or more second force coupler components are one or more of operatively connectable with and disconnectable from the one or more first force coupler components as a unit.

10. The device of claim 9, further comprising a cap component, a plunger component, and one or more detent components;
wherein the plurality of force distribution components, the plurality of spreader components, the one or more second force coupler components, the one or more cap components, the one or more plunger components, and the one or more detent components are operatively connectable with the one or more first force coupler components as a unit;
wherein the cap component comprises one or more first recesses and one or more second recesses;
wherein the plunger component comprises one or more first passages and one or more second passages;
wherein the cap component, upon receipt of the one or more detent components in the one or more first recesses and in the one or more first passages, serves to allow force transmission between the one or more first force coupler components and the unit based on a first direction of angular rotation of the unit;
wherein the cap component, upon receipt of the one or more detent components in the one or more second recesses and in the one or more first passages, serves to allow force transmission between the one or more first force coupler components and the unit based on a second direction of angular rotation of the unit; and
wherein the plunger component, upon receipt of the one or more detent components in the one or more second passages, serves to allow relocation of the one or more detent components among the one or more first recesses and the one or more second recesses.

11. The device of claim 10, wherein the plurality of force distribution components, the plurality of spreader components, the one or more second force coupler components, the one or more cap components, the one or more plunger components, and the one or more detent components are operatively connectable with and disconnectable from the one or more first force coupler components as a unit.

12. The device of claim 5, wherein the plurality of force distribution components, the plurality of spreader components, and the one or more second force coupler components serve to allow one or more finite angular movements between the one or more first force coupler components and the plurality of force distribution components; and
wherein one or more of the one or more finite angular movements is less than or equal to five degrees.

13. The device of claim 5, wherein the plurality of force distribution components, the plurality of spreader components, and the one or more second force coupler components serve to allow one or more finite angular movements between the one or more first force coupler components and the plurality of force distribution components; and
wherein one or more of the one or more finite angular movements is less than or equal to four degrees.

14. The device of claim 5, wherein the plurality of force distribution components, the plurality of spreader components, and the one or more second force coupler components serve to allow one or more finite angular movements between the one or more first force coupler components and the plurality of force distribution components; and
wherein one or more of the one or more finite angular movements is less than or equal to three degrees.

15. The device of claim 1, wherein one or more of the plurality of force distribution components comprise one or more first protuberances;
wherein one or more of the one or more force coupler components comprise one or more second protuberances; and
wherein movement of the one or more force coupler components from a first force transmission position set of the plurality of third positions to a second force transmission position set of the plurality of third positions, upon operative location of the plurality of force distribution components relative to the one or more force coupler components, serves to one or more of abut and engage a portion of one or more of the one or more first protuberances with a portion of one or more of the one or more second protuberances and promote force transmission between the plurality of force distribution components and the one or more force coupler components.

16. The device of claim 1, wherein one or more of the plurality of force distribution components comprise one or more first protuberances;
wherein one or more of the one or more force coupler components comprise one or more second protuberances; and
wherein movement of the one or more force coupler components from a first position set of the plurality of third positions to one or more second position sets of the plurality of third positions, upon operative location of the plurality of force distribution components relative to the one or more force coupler components, serves to contact one or more portions of one or more of the one or more first protuberances with one or more portions of one or more of the one or more second protuberances and produce one or more audible sounds.

17. The device of claim 1, wherein one or more of the plurality of force distribution components comprise one or more first protuberances;
wherein one or more of the one or more force coupler components comprise one or more second protuberances; and
wherein movement of the one or more force coupler components from a first position set of the plurality of third positions to one or more second position sets of the plurality of third positions, upon operative location of the plurality of force distribution components relative to the one or more force coupler components, serves to contact one or more portions of one or more of the one or more first protuberances with one or more portions of one or more of the one or more second protuberances and produce one or more clicks.

18. The device of claim 1, further comprising the one or more force coupler components, wherein the one or more force coupler components comprise a wrench lever component;
wherein the plurality of force distribution components comprise a plurality of gear shoe components that, upon operative location of the plurality of gear shoe components relative to the wrench lever component, are movable among the plurality of first positions relative to the wrench lever component; and
wherein the plurality of spreader components comprise a plurality of wedge components that are movable among the plurality of second positions relative to the plurality of gear shoe components.

19. The device of claim 1, further comprising the one or more force coupler components, wherein the one or more force coupler components comprise a first wrench lever component that is pivotably connectabale with a second wrench lever component.

20. The device of claim 1, wherein the one or more substantially flat first face portions comprise a first contactable face portion, wherein the one or more substantially flat second face portions comprise a second contactable face portion that comprises a rake that is less than or equal to forty degrees and greater than or equal to five degrees; and
wherein location of the plurality of spreader components at one or more force transmission position sets of the plurality of second positions causes, through employment of contact of the first contactable face portion with the second contactable face portion, location of the plurality of force distribution components at one or more force transmission position sets of the plurality of first positions.

21. The device of claim 1, wherein the one or more substantially flat first face portions comprise a first contactable face portion, wherein the one or more substantially flat second face portions comprise a second contactable face portion that comprises a rake that is approximately ten degrees; and
wherein location of the plurality of spreader components at one or more force transmission position sets of the plurality of second positions causes, through employment of contact of the first contactable face portion with the second contactable face portion, location of the plurality of force distribution components at one or more force transmission position sets of the plurality of first positions.

22. The device of claim 1, wherein the force distribution component comprises a first force distribution component, wherein the plurality of force distribution components comprise a second force distribution component that comprises one or more substantially flat third face portions;
wherein the spreader component comprises a first spreader component, wherein the plurality of spreader components comprise a second spreader component that comprises one or more substantially flat fourth face portions;
wherein location of the plurality of spreader components at one or more force transmission position sets of the plurality of second positions causes, through employment of contact of one or more of the one or more substantially flat first face portions with one or more of the one or more substantially flat second face portions and contact of one or more of the one or more substantially flat third face portions with one or more of the one or more substantially flat fourth face portions, location of the plurality of force distribution components at one or more force transmission position sets of the plurality of first positions.

23. A device, comprising:
a plurality of force distribution components that, upon operative location of the plurality of force distribution components relative to one or more first force coupler components, are movable among a plurality of first positions relative to the one or more first force coupler components, wherein the plurality of force distribution components comprise a force distribution component that comprises one or more substantially flat first face portions;
a plurality of spreader components that are movable among a plurality of second positions relative to the plurality of force distribution components, wherein the plurality of spreader components comprise a spreader component that comprises one or more substantially flat second face portions and one or more substantially curved face portions; and
one or more second force coupler components that are movable among a plurality of third positions relative to the plurality of spreader components;
wherein the plurality of force distribution components, the plurality of spreader components, and the one or more second force coupler components serve to allow one or more finite angular movements between the one or more first force coupler components and the plurality of force distribution components, wherein one or more of the one or more finite angular movements is less than or equal to five degrees.

24. The device of claim 23, wherein location of the one or more second force coupler components at one or more force transmission position sets of the plurality of third positions causes, through employment of contact of one or more of the one or more substantially curved face portions with one or more portions of a force coupler component of the one or more second force coupler components, location of the plurality of spreader components at one or more force transmission position sets of the plurality of second positions that causes, through employment of contact of one or more of the one or more substantially flat first face portions with one or more of the one or more substantially flat second face portions, location of the plurality of force distribution components at one or more force transmission position sets of the plurality of first positions.

25. A method, comprising the steps of:
selecting a plurality of force distribution components that, upon operative location of the plurality of force distribution components relative to one or more force coupler components, are movable among a plurality of first positions relative to the one or more force coupler components, wherein the plurality of force distribution components comprise a force distribution component that comprises one or more substantially flat first face portions; and
selecting a plurality of spreader components that are movable among a plurality of second positions relative to the plurality of force distribution components, wherein the plurality of spreader components comprise a spreader component that comprises one or more substantially flat second face portions;
wherein location of the plurality of spreader components at one or more force transmission position sets of the plurality of second positions causes, through employment of contact of one or more of the one or more substantially flat first face portions with one or more of the one or more substantially flat second face portions, location of the plurality of force distribution components at one or more force transmission position sets of the plurality of first positions.

26. The method of claim 25, wherein the one or more force coupler components comprise one or more first force coupler components, and further comprising the steps of:
selecting one or more second force coupler components that are movable among a plurality of third positions relative to the plurality of spreader components; and
assembling the plurality of force distribution components, the plurality of spreader components, and one or more second force coupler components into a unit that is one or more of operatively connectable with and disconnectable from the one or more first force coupler components;
wherein location of the one or more second force coupler components at one or more force transmission position sets of the plurality of third positions causes, through employment of contact among one or more portions of the spreader component and one or more portions of a force coupler component of the one or more second force coupler components, location of the plurality of spreader components at one or more force transmission position sets of the plurality of second positions.

27. The method of claim 26, wherein the one or more first force coupler components comprise a wrench lever component that, at a first instant in time, is operatively connectable with a pawl mechanism drive element, and further comprising the step of:
substituting the unit for the pawl mechanism drive element through operative connection of the unit with the wrench lever component at a second instant of time subsequent to the first instant in time.
